(19) United States
(12) Patent Application Publication
(10) Pub. No.: US 2004/0071453 A1
(43) Pub. Date: Apr. 15, 2004

(54) Method and system for producing interactive DVD video slides

(76) Inventor: Harold M. Valderas, Austin, TX (US)

Correspondence Address: DVD Power Tools, Suite A-126, 12708 Riata Vista Circle, Austin, TX, 78727, US

(21) Appl. No.: 10/628,302

(22) Filed: Jul. 28, 2003

Related U.S. Application Data
(60) Provisional application No. 60/417,050, filed on Oct. 8, 2002.

(51) Int. Cl. H04N 5/781

(52) U.S. Cl. 386/125; 386/126

(57) ABSTRACT

A method for producing an interactive presentation for a DVD video player, based upon a slide presentation, like a PowerPoint presentation in which the slide presentation is received, slide content is extracted and associated with a video frame at a position within the video frame based upon the slide presentation. The video frame may be linked with another video frame to provide a user-navigable path between the video frames. The slide content may be positioned within a safe area of the video frame to facilitate display of the presentation on different monitors and televisions. The video frame may be combined with a video clip that loops indefinitely, drawing the audience's attention to the slide content. In one embodiment, an image of a navigation bar is inserted into a title layer and controls are associated with the navigation bar.

### CROSS-REFERENCES TO RELATED APPLICATIONS

Pursuant to 35 USC §119(e), this application claims priority to and benefit of U.S. Provisional Patent Application Serial No. 60/417,050, filed Oct. 8, 2002, the disclosure of which is incorporated herein in its entirety for all purposes.

### FIELD OF INVENTION

The present invention is in the field of presentation delivery systems for sales, marketing, technical, financial, academic, trial presentations, training and the like and, more particularly, to a method and system for producing interactive DVD video slides.

### BACKGROUND

Presentations provide an audience with visual and/or audio imagery to increase the amount of information retained by audience members. Stimulating more than one of an audience member's senses can communicate more information to an audience member than can be transferred via a single sense. For example, conventional presentations typically involve a narrator and a slide projection. In particular, a projector may display bullets with text to provide a visual indication of major points discussed during a presentation.

Presentations are widely produced as color slides generated by software such as PowerPoint by Microsoft Corporation and displayed on a wall or screen via a liquid crystal display (LCD) projector. The use of color stimulates the visual perception of the slides to the audience to a greater degree than black and white slides. Further presentations add an image such as a digital picture of a product, for instance, to enhance visual stimulation. However, set up issues and technical problems during presentations significantly detract from a presentation's impact on the audience. For instance, the audience members often find themselves watching as the narrator attempts to solve technical issues involved with displaying the presentation. The narrator stumbles through the preferences to determine why the screen is not being projected even though the equipment is physically connected and then through the filing system to determine where the presentation file is located. Even worse, the computer freezes or crashes during the presentation and the narrator interrupts the presentation, possibly even turning lights back on to determine what has happened. Such problems unnecessarily jeopardize the narrator's business relationship with audience members.

Some narrators avoid the inherent problems associated with the use of computers during slide presentations and resort to projectors for slides, transparencies, or paper. These presentations reduce the likelihood of distractions resulting from unreliable equipment while increasing the both audile and visual distractions resulting from the narrator flipping through slides, inserting and removing slides, placing the slides on the projector in a position that cuts off part of the presentation, and the like.

Further narrators avoid the problems inherent with computers and projectors by storing the presentation on a videotape, like VHS. Videotapes reduce interaction between the narrator and the audience and introduce distractions such as stopping and starting the video and turning lights on and off. These presentations also severely limit the narrator's ability to adjust the length of the presentation for changes in the amount of time available for the presentation. In particular, when 15 minutes of a presentation is lost as a result of a delay in beginning the presentation or a prior narrator overrunning the allotted time, a narrator must reduce the length of the video presentation. The narrator may remove material from the video presentation by fast-forwarding through a portion or shutting off the video presentation before it finishes. Fast-forwarding rarely seems to work well and tends to distract the audience. Cutting off the video presentation may be less distractive, but may reduce the impact of certain points, particularly the points that were not covered by the video.

### SUMMARY OF THE INVENTION

The problems identified above are in large part addressed by methods and systems for producing interactive presentations for a Digital Versatile Disk (DVD) video player, based upon a presentation in another physical or electronic format. Embodiments of the invention may receive the slide presentation, extract the slide content, associate the slide content with a video frame at a position within the video frame based upon the slide presentation, and link the video frame with another video frame to provide a path between the video frames, navigable by user input via the playback controls, to create the interactive video presentation. The slide content may be positioned within a safe area of the video frame to avoid clipping or other problems associated with displaying the presentation on a variety of monitors and televisions. Several embodiments combine the video frame with one or more frames of a video background such as a video clip that plays for a specific period of time or loops indefinitely, drawing the audience's attention to visual aspect of the presentation such as text or images. In many embodiments, the looping nature of the video slide is seamless, or substantially seamless. A translucent layer with a color tone may be inserted between the foreground and the video background, for instance, to improve the readability of text in the foreground or to attenuate characteristics of a distracting video background. Looping video sequences can also be incorporated in the form of animated title bars or moving video within a small sub-window (picture in picture effects). In many embodiments, one or more audio tracks may be associated with a video frame. In one embodiment, an image of a navigation bar is inserted into the foreground, such as on a title layer, during video generation and controls are associated with the navigation bar image during authoring. The controls for the navigation bar may default to the subsequent video frame of the presentation so the narrator may press “Enter”, “Select” or use a personal computer mouse to progress to that video frame. Such embodiments may produce the video presentation based upon one or more PowerPoint files.

In other embodiments, multiple lengths of a single presentation and/or more than one presentation may be stored on a single medium with a menu system to provide easy access to the presentations. In some embodiments, a menu may link several presentations and a sub-menu may link control files to offer different lengths of the same presentation. The control files may link video frames of the video presentation in different combinations to provide different presentation lengths based upon an interrelationship between slides of the slide presentation. For example, the medium may comprise a presentation designed to last approximately 45 minutes. The narrator may choose or map a subset of slides and/or video clips, or portions thereof, to reduce the length of the presentation to 30 minutes and 15 minutes. After the video presentation is authored, at the beginning of the presentation, the narrator may choose the desired presentation length based upon the amount of time actually allotted for the presentation via a menu system controlled by playback controls such as forward, reverse, and play controls.

### BRIEF DESCRIPTION OF THE DRAWINGS

Other objects and advantages of the invention will become apparent upon reading the following detailed description and upon reference to the accompanying drawings in which, like references may indicate similar elements:

FIG. 1 depicts an embodiment of a system to produce an interactive presentation and burn the interactive video presentation on a DVD;

FIG. 2 depicts an embodiment of a system to produce an interactive presentation from a digital or physical copy of a presentation;

FIG. 3 depicts an example flow chart to produce an interactive presentation for a video player having playback controls based upon a slide presentation according to one embodiment;

FIG. 4 depicts an embodiment of a machine-accessible medium comprising instructions to produce an interactive presentation for a video player based upon a slide presentation; and

FIGS. 5-6 depict embodiments of video slides.

### DETAILED DESCRIPTION OF EMBODIMENTS

The following is a detailed description of example embodiments of the invention depicted in the accompanying drawings. The example embodiments are in such detail as to clearly communicate the invention. However, the amount of detail offered is not intended to limit the anticipated variations of embodiments, but on the contrary, the intention is to cover all modifications, equivalents, and alternatives falling within the spirit and scope of the present invention as defined by the appended claims. The detailed descriptions below are designed to make such embodiments obvious to a person of ordinary skill in the art.

Generally speaking, the present invention contemplates a system and method for producing video slides, an interactive presentation for a Digital Versatile Disc (DVD) player, based upon a slide presentation such as a presentation graphics document. The following text discloses video slides according to the present invention, methods and systems to produce such video slides, and an interactive presentation for a video player such as a DVD that is based upon a slide presentation, like a PowerPoint presentation. Embodiments may receive the slide presentation, extract slide content, associate the slide content with a video frame at a position within the video frame based upon the slide presentation, and link the video frame with another video frame to provide a path between the video frames, navigable by user input via playback controls. The slide content may be positioned within a safe area of the video frame to facilitate display of the presentation on different monitors and televisions. Several embodiments combine the video frame with a video clip that may loop indefinitely, drawing the audience's attention to the slide content. In many of these embodiments, the looping nature of the video slide is seamless, or substantially seamless. In one embodiment, an image of a navigation bar is inserted into a title layer and controls are associated with the navigation bar. Other embodiments include a DVD having a digital video presentation produced from a PowerPoint slide presentation.

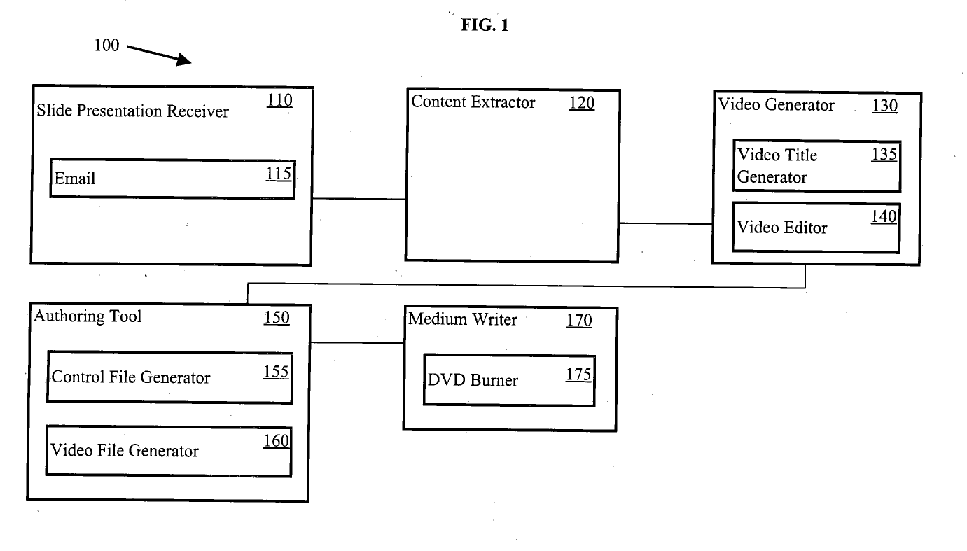

Turning now to the drawings, FIG. 1 depicts an embodiment of a system 100 to produce an interactive video presentation for a player having playback controls based upon a slide presentation. System 100 includes a slide presentation receiver 110, a content extractor 120, a video generator 130, an authoring tool 150, and a medium writer 170. Slide presentation receiver 110 may receive a slide presentation in the form of an electronic file such as a Microsoft PowerPoint presentation. In some embodiments, the slide presentation may be received via email 115 or via a network connection. For example, a person may review a web site describing a video presentation generated from a PowerPoint file and submit a slide presentation to this embodiment by uploading the slide presentation to an address and/or directory or by attaching the presentation to email 115.

Content extractor 120 may extract slide content from a slide of the slide presentation. In particular, content extractor 120 retrieves text and/or images such as Joint Photographic Experts Group (JPEG) files from the slide. On the other hand, slide content may be extracted in a format other than JPEG files and converted into JPEG files. For example, text titles, subtitles, bullet points, descriptions, or the like may be extracted as text for insertion into a title layer and be associated with one or more video frames. Logos, pictures, organizational charts and other images may be extracted as JPEG files or as Windows Metafiles (WMF), Picture (PCT) files, Tagged Image File Format (TIFF) files, Bitmap (bmp) files, Graphics Interchange Format (GIF) files, or similar type files, and converted into JPEG files. In other embodiments, slide content may be extracted as or converted into an image format other than a JPEG file.

Video generator 130 may couple with content extractor 120 to produce a first video frame based upon the slide content, wherein the slide content is at a position within the first video frame based upon the location from which the slide content is extracted from the slide. In many embodiments, video generator 130 associates the slide content with a time period. In some of these embodiments, video generator 130 produces more than one video frame 130 based upon the slide content of the slide to incorporate a background video clip.

Video generator 130 may include a video title generator 135 and a video editor 140. Video title generator 135 may receive slide content extracted from a slide of a slide presentation and insert the slide content into a title layer of a video title master document. In many embodiments, the slide content may be placed in the foreground of the title layer and a translucent layer having a color-tone may be inserted into the background of the title layer. The translucent layer mutes a background displayed through the alpha channel of the title layer, such as a video clip, to improve the readability of the text in the foreground of the title layer. In other embodiments, the translucent layer having a color tone is inserted for different reasons such as to reduce the chance of distracting an audience from the text or images in the foreground of the title layer.

The slide content is positioned within the title layer based upon the location from which the slide content is extracted from a slide. For example, a company logo may be extracted from the lower left hand corner of a slide. The company logo is extracted as a JPEG file and inserted in the lower left hand corner of the title layer. In many embodiments, the scale of the company logo with respect to the slide height and/or width is maintained when inserting the company logo into the title layer. In several embodiments, the slide content is positioned within a safe area of the title layer to prevent portions of the slide content from being cut-off when displayed on monitors or televisions having various screen dimensions.

A single video title master document is generated for slide presentations that provide common images such as a title bar and company logo in each slide. Then text of each slide inserted into an individual title document based upon the components of the master title document. On the other hand, when a slide presentation has unique graphics on one or more slides such as graphs and the like, a unique video title master document is generated for each of the slides having unique graphics.

Video editor 140 associates slide content with a time period and may associate a video background with the slide content. For example, a video clip related to slide content of a slide and/or related to a theme of the slide presentation may be added as a background for the slide content to give the presentation a dynamic appearance. In particular, the video clip is placed on a time line and set to play for a period of time such as one minute. In some embodiments, the video clip is looped one or more times or endlessly and looping video clips are used to give the appearance of a continuous video. An individual title document is then placed on a higher image layer for the same duration on the video timeline, allowing the video clip to be seen via the alpha channel of the individual video title document. In many embodiments, audio such as music and/or sound is added to the timeline to provide ambiance or narration for the presentation.

In other embodiments, video editor 130 may produce a single video frame including the slide content of one slide of the slide presentation and the video frame is incorporated as a still image into the timeline.

Authoring tool 150 may link the first video frame with the subsequent video frame to provide a path between the video frames, navigable by user input via the playback controls, to create the interactive video presentation. The links often form a map between the video frames to facilitate navigation similar to the slide presentation upon which the video presentation is based. For example, an interactive video presentation is produced based upon slides of a PowerPoint presentation. Text and graphics of each slide are extracted from the slide presentation and used to generate video title documents. A video clip of the slide presentation is incorporated into the interactive video presentation as a video slide using a digital version of the original source of the video clip to provide high quality, full-screen video and Dolby sound with music and narration in English, German, Spanish or any language. Multiple audio or language tracks can be created and played back depending on the presenter's interaction with the DVD. A background video clip of a spinning globe is associated with the alpha channels of video frames and the alpha channel is blended with a tinted, translucent layer to enhance the readability of the text in the title layer foreground. Further, a menu is generated as the title screen for the interactive video presentation to facilitate selection of English, German, Spanish or other language narration or music tracks.

In addition to options for playing each video slide, links associated with a video slide indicate an action in response to user input from the playback controls. A map of links for a presentation establishes the progression and content of the presentation. For example, the links and actions determine what happens upon reaching a video slide such as playing audio track two when the English version of the presentation is selected and responses to user input like return to title screen, proceed to a subsequent slide, jump to a video clip, and return to previous slide.

Authoring tool 150 includes a control file generator 155 and a video file generator 160. Control file generator 155 generates one or more files to associate a link or a map of links with the video slides in a format readable by a video player such as a DVD player. Video file generator 160 generates a video file and/or an audio file in a format readable by the video player such as a universal disc format (UDF).

Medium writer 170 may store the interactive video presentation on a medium in a format accessible by the intended player such as a UDF. For instance, the medium writer 170 may include a DVD burner 175. DVD burner 175 may burn a DVD in a version of UDF adapted to play in a DVD player. In such embodiments, the control file is adapted to provide instructions to the DVD player regarding how to respond to user inputs via a playback controls on the DVD player or on a remote control for the DVD player.

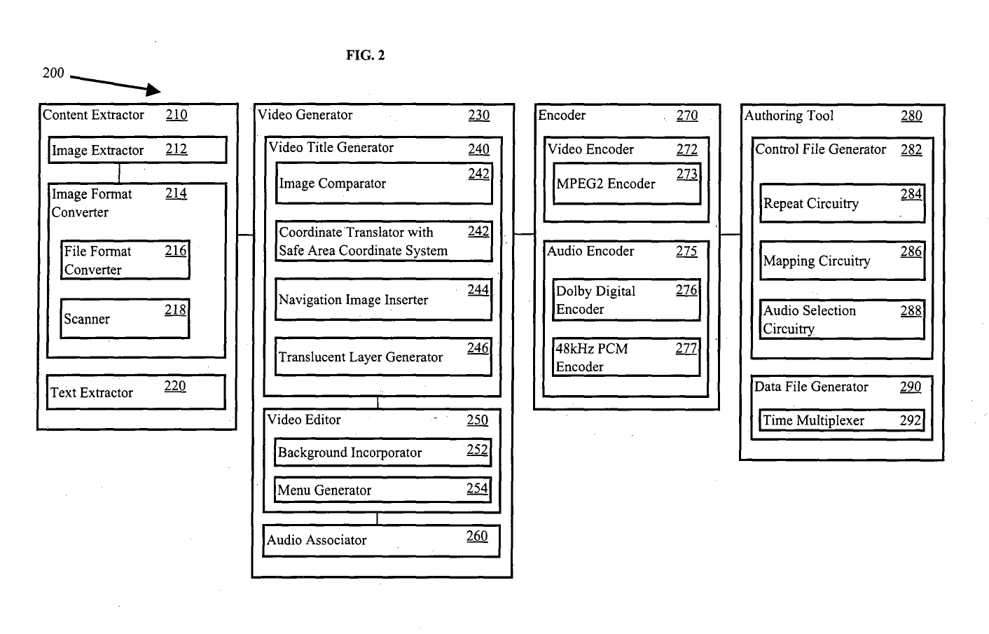

Referring now to FIG. 2, there is shown an embodiment of a system 200 to produce an interactive presentation for a video player based upon a slide presentation. The system 200 may include a content extractor 210; a video editor 230; an encoder 270; and an authoring tool 280. Content extractor 210 extracts slide content from a slide of the slide presentation. For example, a slide includes a title bar, a logo, graphic elements such as pictures of equipment, facilities, people, or the like, and text to describe major points of the presentation. Content extractor 210 captures the images and text in an electronic format. Content extractor 210 also determines the position of the content within the slide to provide a basis for locating the content in a video slide.

Content extractor 210 may include an image extractor 212, an image format converter 214, and a text extractor 220. Image extractor 212 extracts the images in an electronic format such as a JPEG file and may also extract text in an image format. Image extractor 212 couples with image format converter 214 to extract images as or convert images to JPEG files. In the present embodiment, image format converter 214 includes a file format converter 216 and a scanner 218. File format converter 216 converts images from electronic formats other than JPEG into a JPEG file. Scanner 218 converts physical images, such as images on paper or transparencies, into an electronic format.

Text extractor 220 may extract text from a slide of a slide presentation for insertion into a video slide. More specifically, text extractor 220 copies characters or words with a font, font size, and style of text from the slide rather than copying an electronic image of the text. The text is then reproduced or pasted and formatted in the foreground of the video slide such as in the foreground of a title layer.

Video generator 230 may couple with content extractor 210 to produce a video frame having the slide content associated with a position within the first video frame based upon the location from which the slide content is extracted from the slide. For example, the slide content may include a logo in the lower right hand corner of the slide. The logo is extracted by content extractor 210 and pasted into the lower right hand corner of one or more video frames. More specifically, the logo is placed at the lower right hand corner of a safe area of one or more video frames.

In many embodiments, video generator 230 associates the slide content with a time period like one minute to associate with the slide content with a length of time equivalent to the play time of a background video clip.

Video generator 230 may include a video title generator 240, a video editor 250, and an audio associator 260. Video title generator 240 produces one or more video title master documents that include slide content common to multiple slides or unique to a single slide. Then, video title generator 240 adds text that is unique to each slide to the video title master to generate individual video title documents, generating a video-based version of each slide of a slide presentation. In some embodiments, special effects are incorporated into the individual video title documents or the video title master documents to associate visual and/or audio effects with the introduction of text onto a display. For instance, when a video slide is initiated, text may slide on to the display from a distant point off the display or may fold on to the screen from a position perpendicular to the two-dimensional plane of the display.

Video title generator 240 may include an image comparator 242, a coordinate translator with safe area coordinate system 244, a navigation image inserter 246, and a translucent layer generator 248. Image comparator 242 may compare slides, physical or electronic, to determine content common to more than one slide and/or content unique to a slide. In many embodiments, image comparator 242 also compares differences in location of common elements of slide content to determine whether different video master title files should be generated for slides with common elements. For instance, a pointer such as an arrow in a first slide may intentionally be in a different location in the second slide although very close to the same location. Image comparator 242 has a difference discrimination setting that can be set to a fairly large distance for most presentations to provide a margin of error for the extraction method used for the slide presentation. On the other hand, the difference discrimination setting may be set or adapted to detect very small differences in position, allowing the interactive video presentation to incorporate small or subtle changes in positions of text and/or images of the slide presentation.

Coordinate translator with safe area coordinate system 244 may determine where to locate slide content within a video frame based upon a position from which the slide content is extracted. In the present embodiment, the location within the video frame is also based upon the safe area of the video frame. In other embodiments, another area of reference for the positions is selected depending upon the intended monitors or televisions on which to play the presentation. For example, the location of is determined with respect to the upper left hand corner of the slide. The location is translated based upon a ration of the width of the slide content and the width of the safe area. Then, the slide content is inserted at a translated location position in a video frame determined by adjusting the location based upon a ratio of the width of the slide and the width of the safe area. In other embodiments, the location of the slide content within the video frame may be based upon the smaller of the ratio of the slide width to safe area width and the ratio of the slide height to the safe area height.

Navigation image inserter 246 may insert an image adapted for use as a navigation menu or bar. For example, a silver bar is inserted into a video frame to highlight navigation controls for the resulting video slide such as “previous slide”, “main menu”, and “next slide”. In some of these embodiments, the video player may insert triangles in the silver bar, based upon instructions incorporated via authoring tool 270, to indicate a next slide link and previous slide link, and a square to indicate a main menu link. In several of these embodiments, a triangle or square associated with the navigation links may be highlighted to indicate the default selection if the user presses an “enter” button (or “select” or “OK” button, depending upon the manufacturer of the video player) on a control panel of the video player.

Translucent layer generator 248 may blend a translucent image having a color tone with the alpha channel of a video frame. The alpha blending is incorporated into one or more frames, in many instances based upon the video background to be integrated with the video frame. The translucent layer provides softer transitions between foreground images and text and the background video clip and, in some embodiments, is adapted to provide a consistent color scheme throughout the presentation.

Video editor 250 may couple with video title generator 240 to combine the individual video title documents on a time line and associate the individual video title documents with a time period substantially equal to the length of a background video clip. Video editor 250 produces one or more video files containing the individual video title documents and, when applicable, related audio documents.

Video editor 250 may include a background incorporator 252 and a menu generator 254. Background incorporator 252 selects and integrates a video clip with an individual title document as a background. In many embodiments, integrating the background performed by alpha blending, or blending the background video clip with the alpha channel of the individual title document.

The video clip and/or instructions associated with the video clip may be adapted to provide a seamlessly, or substantially seamlessly, looping video background. Providing a substantially seamless, looping video background is designed to minimize distraction resulting from starting and stopping the video background. In some embodiments, a transitional effect is incorporated into the video clip to provide a substantially seamless transition. In other embodiments, a video frame at or near the end of the video clip is selected to be the end because the video frame is similar to a video frame at or near the start of the video clip.

Menu generator 254 may produce one or more menu files to facilitate navigation to different parts of a presentation. The menu files include video and audio of specific lengths of time and, in many embodiments, substantially equal lengths of time. In some embodiments, more than one presentation may be combined for storage on a single medium so a menu is generated to provide navigation to and/or between interactive video presentations. In other embodiments, menu generator 254 generates a list of slide titles, descriptions, and/or the like, the provide navigation to different parts of the interactive presentation such as to major sections of the presentation. In some of these embodiments, index marks or another indication can be incorporated into a slide presentation, like a PowerPoint presentation, to provide a basis for selecting the slides to incorporate into the menu. In other embodiments, the slides are selected based upon a number of slides, the video title master document associated with the video frame, or a selection by a user.

Audio associator 260 can provide music or sound to accompany a video slide. The music or sound can include narration for parts of an interactive presentation. In several embodiments, narration is provided in more than one language and/or for more than one type of audience. For instance, presentations stored on a medium may include technical and non-technical presentations in German, French, Russian, and Spanish. In particular, the visual portions of a technical presentation to a German audience include video slides for the technical presentation accompanied by an audio track having German narration. On the other hand, the non-technical version of the presentation may simply skip video slides having very technical content, skipping the German narration of those slides as well.

Encoder 270 may encode an individual title document or another output of video generator 230 to produce a video file in a video format such as MPEG2 and, when applicable, an audio file in a format such as AC-3. In many embodiments, encoder 270 may include part of an export function of video editor 250. In other embodiments, encoder 270 may include part of an import function of authoring tool 280.

Encoder 270 may include video encoder 272 and audio encoder 275. Video encoder 272 encodes, reformats, or converts video frames produced by video generator 230 into a video file in a format compatible with authoring tool 280. In many of these embodiments, encoding the video frames generates a video format that is readable by the video player or players intended to play the interactive video presentation. In the present embodiment, video encoder 272 includes an MPEG2 encoder 273 to format the individual video title documents into a format readable by players such as DVD players.

Audio encoder 275 encodes audio associated with video frames into a format readable by authoring tool 280. In particular, audio encoder 275 includes Dolby digital encoder 276 and 48 kHz PCM encoder 277. Audio may be encoded into one or more formats depending upon the intended player. For example, some DVD players couple with audio equipment, allowing either Dolby or 48 kHz PCM audio formats to play.

Authoring tool 280 may link the first video frame with a subsequent video frame to provide a path between the video frames, navigable by user input via the playback controls, to create the interactive video presentation. Authoring tool 280 also formats data on a medium in a manner accessible by the intended video player(s) such as UDF. Authoring tool 280 may include a control file generator 282 and a data file generator 290. Control file generator 282 generates a control file to associate with or incorporate with video files including video slides of an interactive video presentation to store on a medium accessible by a video player.

Control file generator 282 may associate controls or links with a video slide such as “Previous Slide”, “Subsequent Slide”, and “Menu” so that the video player may respond to user input corresponding to those instructions. In some of these embodiments, a default selection, or user input, is associated with the video slide such as “Subsequent Slide’ so that the user can press “Enter” on a control panel of the video player to progress to the next video slide in the interactive video presentation. In several embodiments, the default selection may be based upon the order in which the video slides are imported into authoring tool 280, the order in which links are associated with the video slides, the order in which the slides are linked to indicate a sequence of video slides for a presentation, or the like.

Control file generator 282 may include repeat circuitry 284, mapping circuitry 286, and audio selection circuitry 288. Repeat circuitry 284 incorporates an instruction to repeat one or more video frames including a video slide one or more times. For example, 360 video frames are produced by extracting content from a slide of a slide presentation and incorporating a minute of a video clip as a background for the slide content. The 360 frames are encoded as MPEG2 files and imported into authoring tool 280. Control file generator 282 generates a control file to associate with the 360 video frames, identifying the video frames as a video slide, and to repeat the video frames in an endless loop until a user instructs the player to perform another available function that causes the player to stop playing the video frames, or video slide. In some embodiments, the 360 video frames may be associated with the same chapter and the chapter includes a video slide. Other video slides, however, play from the first video frame to the last video frame and wait at the last video frame until the user enters a command.

Mapping circuitry 286 determines a map of paths to interconnect multiple video frames of the video presentation, based upon an interrelationship between slides of the slide presentation, wherein the multiple video frames are associated with the slides. More specifically, mapping circuitry 286 generates links in a form like a decision tree to provide instructions to a video player regarding how to respond to user input. For example, a user may be reviewing a presentation including multiple options such as technical or non-technical, English or Spanish, and within these options, sub-options regarding the desired length of the presentation such as a 15-minute overview or a one-hour, full discussion. The user elects to review a 15-minute, technical overview in English. When the user is at video slide number one and presses a button to instruct the player to move to the next video slide, the player reviews instructions of a control file associated with the current video slide to determine how to respond to the user input. Since the user elected a 15-minute overview, the player determines that the next slide associated with the 15-minute technical overview is video slide number 15 and jumps from video slide number one to video slide number 15 in response to the user input. Similarly, if the user presses a button to instruct the player to return to the previous video slide, the player reviews the data from the control file to determine that the previous slide is slide number one. In some embodiments, the player remembers the previous video slide and, thus, does not access the control file each time to determine the previous video slide. In other embodiments, the video player copies video slide sequences of one or more of the presentation options, or the control file, into a buffer so the control file is not accessed for each decision.

Audio selection circuitry 288 incorporates options for the user to select the type and format of audio to play in concert with a video slide. For instance, a technical and non-technical narration may be associated with the same video slide in English and Spanish. Audio selection circuitry 288 incorporates instructions in the control file to indicate the audio to play with the video slide based upon options selected by the user.

Data file generator 290 may format video and/or audio for storage on a medium in a format readable by a video player. In the present embodiment, data file generator 290 includes a time multiplexer 292 to time multiplex various audio and video options on a medium such as a DVD. In particular, an interactive presentation may provide the option of subtitles and multiple languages. The video slide that does not include subtitles may be time multiplexed with the video with subtitles. Similarly, the English audio track may be time multiplexed with a Spanish audio track for the video slide. Alternative embodiments may store the different audio and video on different tracks or files on medium or may store the data with code multiplexing, or the like.

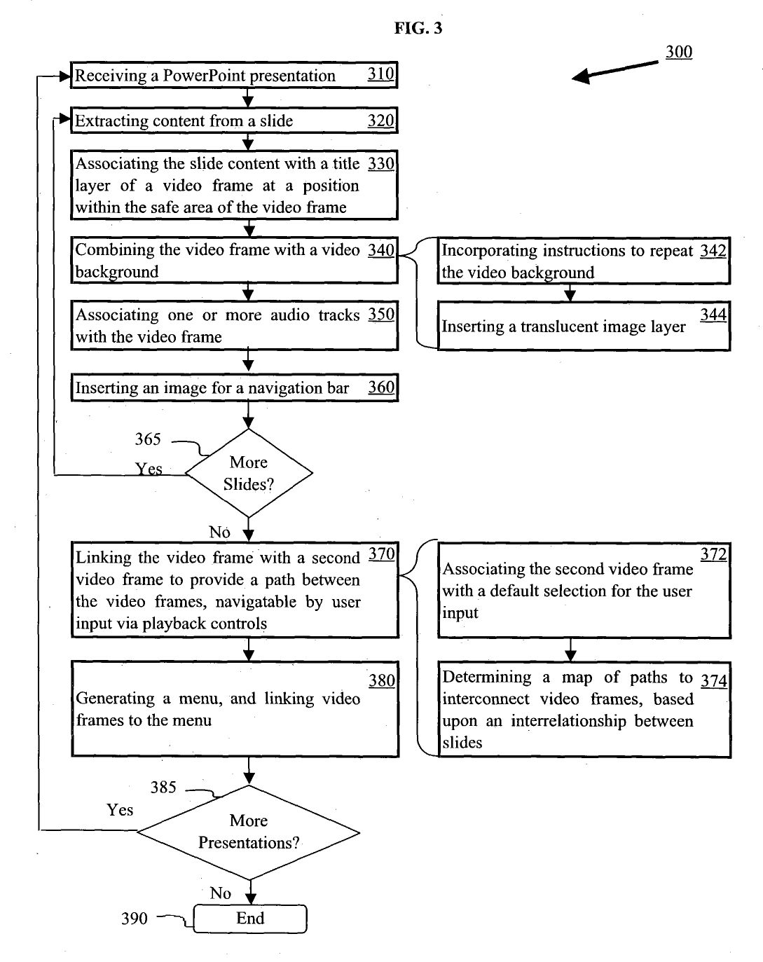

FIG. 3 depicts an example flow chart of an embodiment 300 to produce an interactive presentation for a video player based upon a slide presentation. Embodiment 300 begins with element 310, receiving a PowerPoint presentation. Receiving a PowerPoint presentation receives a slide presentation in a form such as paper or electronic, from which content such as text and images can be extracted. In other embodiments, other types of presentations are received such as other types of electronic or paper presentations.

In element 320, the content of the slide is extracted and associated with a title layer of a video frame at a position within the safe area of the video frame in element 330. For instance, the images or text of the PowerPoint presentation may be scanned in with a scanner and optical character recognition software. The images are imported into a video title generator to produce a video title master document. The spelling of the text can be spell checked to correct errors inherent to character recognition software and inserted into the title layer. In many of these embodiments, the video title master document is modified with the text of a slide to produce an individual video title document for slides of the slide presentation. In several embodiments, a reference point within a slide is selected and the relative positions of the content of the slide are measured with respect to that reference point. The positions are then translated into a safe area of a video frame in the title layer based upon the reference point. Then, the slide content is translated and pasted into the title layer. In several embodiments, the text and title bar are set to opaque and the logo is set to translucent.

In some embodiments, the individual video title documents can be imported into a video editor to associate the individual video title documents with a period of time on a timeline. The period of time is based upon the length of a video clip selected to be a video background for the individual video title document and the individual video title document is combined with the video background (element 340). Combining the video frame with the video background, element 340, may include incorporating instructions to repeat the video background, element 342, and inserting a translucent image layer, element 344.

Incorporating instructions to repeat the video background, element 342, may include providing instructions in a control file to repeat the video background one or more times. For example, the video background may loop several times while displaying the slide content on the title layer, creating a dynamic slide. Many such embodiments are adapted to maintain interest of an audience. Some of these embodiments further include element 344, inserting a translucent image layer, to draw the audience to the motion of the slide while muting the motion of the background video to an extent to avoid distracting the audience from the slide content.

Element 350, associating one or more audio tracks with the video frame, may integrate sound with the video frames produced from a slide to further engage the audience in the interactive video presentation. In particular, the sound may include background noises, music and/or narration for parts of a video slide. For example, technical aspects of a manufacturing process described during a presentation are partially narrated via an audio track. In some embodiments, the entire interactive presentation may be narrated via audio tracks. In many of these embodiments, the video background loops but the audio narration plays once straight through, allowing the user to answer questions or fill in additional details tailored for the audience.

An image representing a navigation menu or bar can be inserted into video frames associated with one or more slides (element 360) to provide the user with a visual queue to locate and implement desired navigation. For instance, a vertical or horizontal navigation bar may be located in a non-obtrusive position in every video slide such as the lower left hand corner. During video clips, the navigation bar can be translucent. In other embodiments, the navigation bar is not be inserted during video clips although the navigation links remain available.

Element 365 may determine when additional slides remain in a presentation to repeat elements 320 through 360 for each slide in a slide presentation. After a slide content is extracted and associated with the title layers of video frames, element 370 links a video frame of one video slide with a video frame of a subsequent video slide to provide a path between the video frames, navigable by user input via playback controls of the video player. Element 370 includes element 372 to associate the subsequent video frame with a default selection for the user input and element 374 to determine a map of paths to interconnect video frames, based upon an interrelationship between slides. For example, the first video slide having one or more video frames may be produced from a first slide of a slide presentation and a second video slide may be produced from a subsequent slide of the slide presentation. A link may associate the first with the second video slide, indicating that the second video slide is the subsequent video slide in the interactive video presentation. Further, a link associated the second video slide may indicate that the first video slide is the previous slide for purposes of responding to user input. A map or decision tree of links based upon interconnections between slides of the PowerPoint presentation is generated to provide navigation control via playback controls of a video player.

Element 380 produces a presentation menu video slide to link one or more video slides of the interactive video presentation to a single menu. The presentation video slide is a video slide with descriptions such as slide titles to describe links comprised therein to slides of the interactive video presentation. In other embodiments, element 380 may generate a main menu video slide to link the presentation menus of multiple presentations.

When additional slide presentations are available to produce interactive video presentations, element 385 causes elements 310 through 380 to repeat. In some embodiments, the presentations may also be formatted for a video player and stored on a medium.

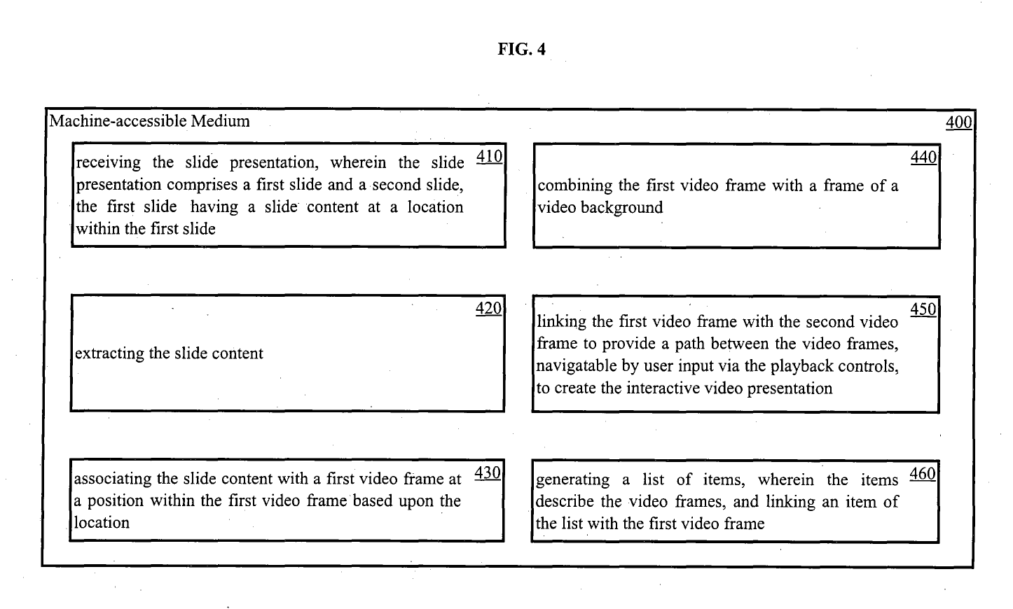

Referring now to FIG. 4, a machine-accessible medium embodiment of the present invention is shown. A machine-accessible medium includes any mechanism that provides (i.e. stores and or transmits) information in a form readable by a machine (e.g., a computer), that when executed by the machine, can perform a method as descirbed below herein. For example, a machine-accessible medium may include read only memory (ROM); random access memory (RAM); magnetic disk storage media; optical storage media; flash memory devices; electrical, optical, acoustical or other form of propagated signals (e.g. carrier waves, infrared signals, digital signals, etc.), and so forth. Several embodiments of the present invention can include more than one machine-accessible medium depending on the design of the machine.

The embodiment 400 may include instructions for receiving the slide presentation, wherein the slide presentation includes a first slide and a second slide, the first slide having a slide content at a location within the first slide (element 410); extracting the slide content (element 420); associating the slide content with a first video frame at a position within the first video frame based upon the location (element 430); combining the first video frame with a frame of a video background (element 440); linking the first video frame with a subsequent video frame to provide a path between the video frames, navigable by user input via the playback controls, to create an interactive video presentation (element 450); and generating a list of items, wherein the items describe the video frames, and linking an item of the list with the first video frame (element 460). Instructions for receiving the slide presentation, wherein the slide presentation includes a first slide and a second slide, the first slide having a slide content at a location within the first slide (element 410) may include receiving a file such as a PowerPoint file.

Instructions for extracting the slide content (element 420) may include extracting foreground images from the slide. For instance, a slide presentation may include JPEG files for each of the graphic elements in the slide and different text for various discussions associated with the remainder of the slides. Instructions provide for importing the JPEG files into a video title generator and generating a video title master document based upon the JPEG files. If text is common to more than one slide, instructions may include copying and pasting text from the slide to the video title generator and into the video title master document. Then, for text that is not common to more than one slide, instructions include copying text from the slide to generate an individual title document. And these instructions may be incorporated into a loop to repeat until video slides are generated for each slide of the slide presentation.

Instructions for associating the slide content with a first video frame at a position within the first video frame based upon the location (element 430) may insert the extracted slide content into the title layer for a video frame at a position located in the video frame by translating coordinates for the slide content within the slide to coordinates with the video frame and, in several embodiments, to coordinates within a safe area within the video frame.

Instructions for combining the first video frame with a frame of a video background (element 440) may combine a video clip with the alpha channel of a title layer to provide a dynamic slide content. Element 440 may include instructions for incorporating instructions to repeat more than one combined frame and instructions for inserting a translucent image layer having a color tone between the slide content and the frame of the video background. The video clip and/or instructions associated with the video clip may further provide a substantially seamless, looping video background to avoid visual distractions involved with starting and stopping the video clip.

Instructions for linking the first video frame with a subsequent video frame to provide a path between the video frames, navigable by user input via the playback controls, to create an interactive video presentation (element 450) may provide instructions to a video player regarding responses to user input when displaying a video slide. Element 450 may include instructions for associating the subsequent video frame with a default selection for the user input, wherein the subsequent video frame represents a subsequent content of the interactive video presentation with respect to the first video frame, based upon the slide presentation. In other embodiments, element 450 may include instructions for determining a map of paths to interconnect multiple video frames of the interactive video presentation, based upon an interrelationship between slides of the slide presentation, wherein the multiple video frames are associated with the slides via contents of the multiple video frames. For example, slides one through five of a slide presentation are displayed in order. Video slides including one or more video frames for each slide, are generated and linked to create an interactive video presentation. The links of the interactive video presentation allow a user to navigate through the video slides in a manner similar to navigating through the slides of the slide presentation.

Instructions for generating a list of items, wherein the items describe the video frames, and linking an item of the list with the first video frame (element 460) may generate a video slide including a menu. In some embodiments, the menu video slide is generated even though there is no corresponding slide in the slide presentation. In other embodiments, the menu slide of the slide presentation is identified via links associated with text of the menu and a corresponding menu is produced as a video slide for the interactive video presentation.

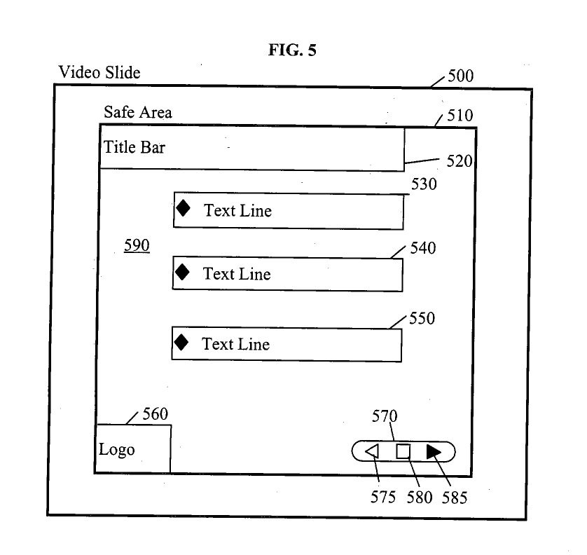

FIG. 5 illustrates an example of a screen shot or one video frame of a video slide 500 displayed on a television or monitor. The video slide includes a safe area 510. The elements located within safe area 510 display within the boundaries of a number of monitors and televisions. The area outside safe area 510 may or may not display within the boundaries of these monitors and televisions.

Video slide 500 also includes contents extracted from a slide including title bar 520; text lines 530, 540, and 550; and logo 560. The contents are on a title layer and may be translucent or opaque. Title bar 520 and logo 560 are common elements to more than one slide of the slide presentation so title bar 520 and logo 560 are incorporated into a video title master document. A navigation bar 570 is also intended to be a common image in all the video slides so is incorporated into the video title master document.

Text lines 530, 540, and 550 are unique in each of the slides of the slide presentation so the text of text lines 530, 540, and 550 is copied from the corresponding slide and pasted in the title layer of an individual video title document. The individual video title document is generated with the video title master document so it incorporates the common content for the slides and the unique text.

Navigation elements, previous video slide 575, main menu 580, and next video slide 585, are located in the navigation bar to highlight navigation controls, or links, for video slide 500. Next video slide 585 is filled rather than an outline to highlight the triangle to indicate that the default or currently selected link will advance to a subsequent video slide in the sequence of video slides of the interactive presentation.

Alpha channel 590 within video slide 500 includes the area of video slide 500 that does not have an opaque foreground image such as text line 530, title bar 520, and the like. Logo 560 is translucent in the present embodiment so the area of logo 560 includes part of alpha channel 590. A background video clip is incorporated in video slide 500 such that the background video clip frame can be seen through alpha channel 590, translucent areas of safe area 510.

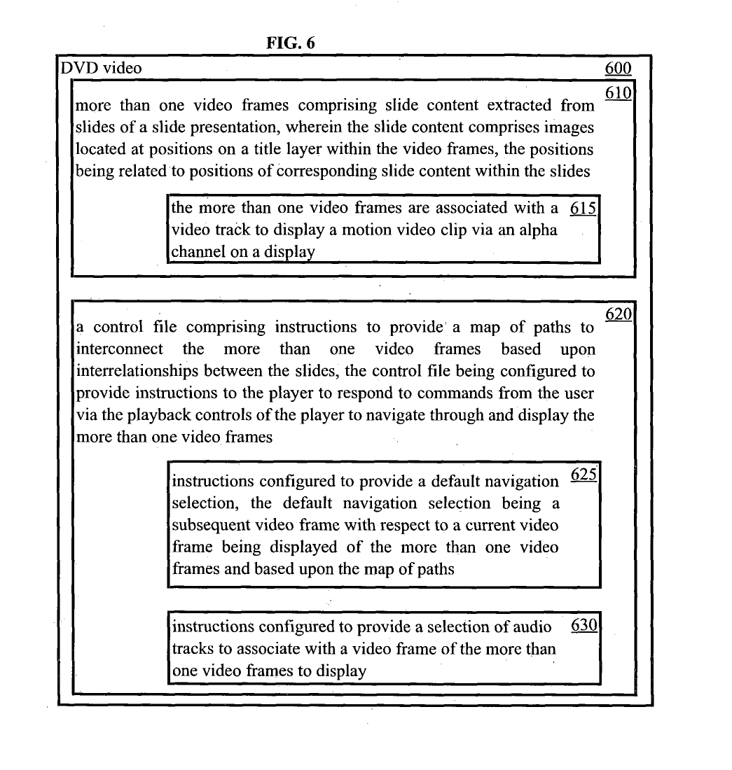

Referring now to FIG. 6, another machine-accessible medium embodiment, a DVD video 600, having an interactive video presentation to interact with a user via playback controls of a player of the present invention is shown. The DVD video 600 may include more than one video frames including slide content extracted from slides of a slide presentation, wherein the slide content includes images located at positions on a title layer within the video frames, the positions being related to positions of corresponding slide content within the slides (element 610); and a control file including instructions to provide a map of paths to interconnect the more than one video frames based upon interrelationships between the slides, the control file being configured to provide instructions to the player to respond to commands from the user via the playback controls of the player to navigate through and display the more than one video frames (element 620).

The video frames of element 610 may include one or more video files organized in groups of one or more video slides. Many or all of the video slides are produced from slide content extracted from the slides of the slide presentation. For example, the images and text of a first slide are extracted and imported into a video title generator. The video title generator generates a video title document based upon the text and images.

A video editor blends a video clip with the alpha channel of one or more of the video title documents and inserts the video title document into a timeline, element 615. The video title document, or a reformatted file based upon the video title document, is imported into a DVD authoring tool.

The DVD authoring tool stores the video of the video title document as an MPEG2 format on DVD video 600 along with the control file (element 620). The control file includes instructions configured to provide a default navigation selection. The default navigation selection is a default link to a video frame of a subsequent video slide with respect to a video frame of a current video slide being displayed based upon the map of paths (element 625). Thus, video slides having dynamic elements may be navigated like slides of a slide presentation via a control panel or remote control of a DVD player.

Further, the control file includes instructions configured to provide a selection of audio tracks to associate with a video frame of the more than one video frames to display (element 630).

It will be apparent to those skilled in the art having the benefit of this disclosure that the present invention contemplates video slides and methods and systems to produce video slides, an interactive presentation for a video player, based upon a slide presentation. It is understood that the form of the invention shown and described in the detailed description and the drawings are to be taken merely as presently preferred examples. It is intended that the following claims be interpreted broadly to embrace all the variations of the preferred embodiments disclosed.

What is claimed is:

1. A method to produce an interactive video presentation for a DVD player having playback controls based upon a slide presentation, the method comprising:
receiving the slide presentation, wherein the slide presentation comprises a first slide and a second slide, the first slide having a slide content at a location within the first slide;
extracting the slide content;
associating the slide content with a first video frame at a position within the first video frame based upon the location; and
linking the first video frame with a subsequent video frame to provide a path between the video frames, navigable by user input via the playback controls, to create the interactive video presentation.

2. The method of claim 1, further comprising combining the first video frame with a frame of a video background.

3. The method of claim 2, wherein combining the first video frame comprises incorporating instructions to repeat more than one combined frame.

4. The method of claim 2, wherein combining the first video frame with a frame of a video background comprises combining the first video frame with a substantially seamless, looping video background.

5. The method of claim 2, wherein combining the first video frame comprises inserting a translucent image layer having a color tone between the slide content and the frame of the video background.

6. The method of claim 1, further comprising associating an audio track with the first video frame.

7. The method of claim 1, further comprising inserting an image for a navigation bar in the first video frame.

8. The method of claim 1, further comprising generating a list of items, wherein the items describe the video frames, and linking an item of the list with the first video frame.

9. The method of claim 1, wherein receiving the slide presentation comprises receiving a PowerPoint file.

10. The method of claim 1, wherein extracting comprises extracting foreground images from the slide.

11. The method of claim 1, wherein associating comprises invoking a video generator to associate the slide content with a title layer of the first video frame.

12. The method of claim 1, wherein associating comprises locating the slide content within a safe area of the first video frame.

13. The method of claim 1, wherein linking comprises associating the subsequent video frame with a default selection for the user input, wherein the subsequent video frame represents a subsequent content of the interactive video presentation with respect to the first video frame, based upon the slide presentation.

14. The method of claim 1, wherein linking comprises determining a map of paths to interconnect multiple video frames of the video presentation, based upon an interconnections between slides of the slide presentation associated with contents of the multiple video frames.

15. A system to produce an interactive video presentation for a player having playback controls based upon a slide presentation, the system comprising:
an content extractor to extract slide content from a slide of the slide presentation;
a video generator coupled with the content extractor to produce a first video frame having the slide content associated with a position within the first video frame based upon the location from which the slide content is extracted from the slide; and
an authoring tool to link the first video frame with a subsequent video frame to provide a path between the video frames, navigable by user input via the playback controls, to create the interactive video presentation.

16. The system of claim 15, wherein the video generator comprises background circuitry to associate a motion video clip with the first video frame to play the motion video clip as a background on a display and the first video frame as a foreground on the display.

17. The system of claim 16, wherein the video generator comprises translucent layer generator to incorporate an image layer having a color tone between the foreground and the background, wherein a translucency of the image layer is adjusted to modify the readability of text of the slide content.

18. The system of claim 16, wherein the video generator comprises navigation image inserter to incorporate an image representing a navigation bar in the foreground.

19. The system of claim 16, wherein the authoring tool comprises instruction circuitry to incorporate an instruction to repeat the motion video clip while displaying the first video frame.

20. The system of claim 16, wherein the authoring tool comprises circuitry to loop the motion video clip substantially seamlessly while displaying the first video frame.

21. The system of claim 15, wherein the video generator comprises audio association circuitry to associate an audio clip with the first video frame to play the audio clip as the first video frame is displayed.

22. The system of claim 21, wherein the authoring tool comprises audio selection circuitry to incorporate the audio clip in an audio track and associate the audio track with the first video frame in response to a preference, the preference being modifiable by the user via the playback controls.

23. The system of claim 15, wherein the authoring tool comprises mapping circuitry to determine a map of paths to interconnect multiple video frames of the video presentation, based upon an interconnections between slides of the slide presentation associated with contents of the multiple video frames.

24. The system of claim 15, wherein the authoring tool comprises mapping circuitry to associate the subsequent video frame with a default selection for the playback controls, wherein the subsequent video frame represents a subsequent content of the interactive video presentation with respect to the first video frame, based upon the slide presentation.

25. A system to produce an interactive video presentation for a player having playback controls based upon a slide presentation, the system comprising:
an content extractor to extract slide content from a slide of the slide presentation;
a video generator coupled with the content extractor to produce a first video frame based upon the slide content, wherein the slide content is at a position within the first video frame based upon the location from which the slide content is extracted from the slide;
an authoring tool to link the first video frame with a subsequent video frame to provide a path between the video frames, navigable by user input via the playback controls, to create the interactive video presentation; and
a medium writer to store the interactive video presentation on a medium.

26. The system of claim 25, wherein the video generator comprises circuitry to insert the slide content in title layers for the first video frame and other video frames of a video clip.

27. The system of claim 26, wherein the authoring tool comprises circuitry write a control file to cause the player to repeat the video clip.

28. The system of claim 25, wherein the video generator comprises circuitry to insert an image of a navigation bar into the first video frame.

29. A machine-accessible medium having an interactive video presentation to interact with a user via playback controls of a player, the machine-accessible medium comprising:
more than one video frames comprising slide content extracted from slides of a slide presentation, wherein the slide content comprises images located at positions on a title layer within the video frames, the positions being related to positions of corresponding slide content within the slides; and
a control file comprising instructions to provide a map of paths to interconnect the more than one video frames based upon interrelationships between the slides, the control file being configured to provide instructions to the player to respond to commands from the user via the playback controls of the player to navigate through and display the more than one video frames.

30. The machine-accessible medium of claim 29, wherein the machine-readable medium comprises a DVD video.

31. The machine-accessible medium of claim 29, wherein the more than one video frames are associated with a video track to display a motion video clip via an alpha channel on a display.

32. The machine-accessible medium of claim 29, wherein the control file comprises instructions configured to provide a default navigation selection, the default navigation selection being a subsequent video frame with respect to a current video frame being displayed of the more than one video frames and based upon the map of paths.

33. The machine-accessible medium of claim 29, wherein the control file comprises instructions configured to provide a selection of audio tracks to associate with a video frame of the more than one video frames to display.

34. A machine-readable medium containing instructions, which when executed by a machine, cause said machine to perform operations, comprising:
receiving the slide presentation, wherein the slide presentation comprises a first slide and a second slide, the first slide having a slide content at a location within the first slide;
extracting the slide content;
associating the slide content with a first video frame at a position within the first video frame based upon the location; and
linking the first video frame with a subsequent video frame to provide a path between the video frames, navigable by user input via the playback controls, to create an interactive video presentation.

35. The machine-readable medium of claim 34, further comprising combining the first video frame with a frame of a video background.

36. The machine-readable medium of claim 35, wherein combining the first video frame comprises incorporating instructions to repeat more than one combined frame.

37. The machine-readable medium of claim 35, wherein combining the first video frame comprises inserting a translucent image layer having a color tone between the slide content and the frame of the video background.

38. The machine-readable medium of claim 34, further comprising associating an audio track with the first video frame.

39. The machine-readable medium of claim 34, further comprising inserting an image for a navigation bar in the first video frame.

40. The machine-readable medium of claim 34, further comprising generating a list of items, wherein the items describe the video frames, and linking an item of the list with the first video frame.

41. The machine-readable medium of claim 34, wherein receiving the slide presentation comprises receiving a PowerPoint file.

42. The machine-readable medium of claim 34, wherein extracting comprises extracting foreground images from the slide.

43. The machine-readable medium of claim 34, wherein associating comprises invoking a video editor to associate the slide content with the first video frame.

44. The machine-readable medium of claim 34, wherein associating comprises locating the slide content within a safe area of the first video frame.

45. The machine-readable medium of claim 34, wherein linking comprises associating the subsequent video frame with a default selection for the user input, wherein the subsequent video frame represents a subsequent content of the interactive video presentation with respect to the first video frame, based upon the slide presentation.

46. The machine-readable medium of claim 34, wherein linking comprises determining a map of paths to interconnect multiple video frames of the interactive video presentation, based upon an interrelationship between slides of the slide presentation, wherein the multiple video frames are associated with the slides via contents of the multiple video frames.
